(19) United States
(12) Patent Application Publication
(10) Pub. No.: US 2025/0231052 A1
(43) Pub. Date: Jul. 17, 2025

(54) TRACK ASSEMBLY FOR INSPECTION ROBOT SYSTEM

(71) Applicant: Anhui Ronds Science & Technology Incorporated Company, Hefei (CN)

(72) Inventors: Li Guo, Hefei (CN); Weiyin Jia, Hefei (CN)

(21) Appl. No.: 19/095,154

(22) Filed: Mar. 31, 2025

Related U.S. Application Data
(63) Continuation-in-part of application No. PCT/CN2023/121479, filed on Sep. 26, 2023.

(30) Foreign Application Priority Data
Sep. 30, 2022 (CN) 202211214063.8

(51) Int. Cl. G01D 11/30; B65G 35/06

(52) U.S. Cl. CPC G01D 11/30; B65G 35/06

(57) ABSTRACT

The present application relates to a track assembly for an inspection robot system, which includes: a track that defines an inspection path; and a continuous and unbroken drive chain fixedly installed on the track along its extension. The drive chain is engaged with a drive sprocket, which in turn drives the robot along the track. This drive design, with the drive chain-drive sprocket arrangement, offers significant advantages over traditional pulley-rail designs and gear-rack transmission designs. The additional advantage of the regular-shaped closed track is that in applications with a lot of dust, such as mines and underground environments, it can prevent the accumulation of dust in the track groove, which would otherwise affect its use. Moreover, the manufacturing and processing costs of the regular-shaped closed track are lower, while its strength and rigidity can be higher.

### CROSS-REFERENCE TO RELATED APPLICATION

The present application is a continuation-in-part of PCT Application Ser. No. PCT/CN2023/121479 as filed on Sep. 26, 2023, designating the United States, now pending, which claims priority to Chinese Patent Application No. 202211214063.8, filed on Sep. 30, 2022, titled “Track Assembly for Inspection Robot System,” the entire content of which is incorporated herein by reference.

### TECHNICAL FIELD

The present application relates to the field of track inspection technology, specifically to a serial inspection robot system and its track assembly.

### BACKGROUND

Inspection work in long-distance or complex sites, such as utility tunnels and coal mines, is fundamental and crucial for site safety. Due to the multitude of monitoring items and long distances, especially in the case of ultra-long utility tunnels with harsh environmental conditions, strong enclosure, numerous structures, and inconvenient communication, manual inspection of site conditions is extremely difficult and limited in feasibility, and it is also challenging to effectively ensure the personal safety of inspection personnel.

Since robots possess basic characteristics such as perception, decision-making, and execution, they can assist or even replace humans in performing the dangerous, arduous, and complex task of inspection, thereby improving work efficiency and quality.

During operation, inspection robots typically move along a fixed path on a track platform and monitor the environment that needs to be inspected. With the advancement of technology and increasing demand, track inspection robots are gradually being adopted in many places, such as factories, livestock farms, smart farms, municipal utility tunnels, and underground coal mines, etc.

In existing fixed-track inspection robot systems, the drive design generally involves placing a drive mechanism, such as a motor and related transmission components like pulleys, at a fixed position to drive the conveyor belt or conveyor line and the inspection robot installed thereon to move together for inspection.

In existing inspection robot systems, the inspection robot device usually operates as a whole on the track for inspection. Since the inspection robot device may need to work in certain harsh conditions, such as mines, underground locations, and places with flammable dust where explosion-proof standards are strictly required, the design of the inspection robot in such environments should meet explosion-proof requirements, minimize the issue of over-temperature during operation and improve heat dissipation. In some applications with limited space, the inspection robot needs to have a smaller volume. The limitations of the conveyor belt or conveyor line and the track also require the inspection robot to be as lightweight as possible and prevent local overloading. The above and other application environments also impose higher requirements for reliability.

There is a continuous need in the industry for improved inspection robot systems to continuously enhance the performance of inspection robot systems and to mitigate or even eliminate the aforementioned technical defects, as well as to achieve other additional technical advantages.

The information included in the background section of the present application, including any references cited herein and their descriptions or discussions, is included solely for technical reference purposes and is not intended to be construed as limiting the scope of the present application.

### SUMMARY

Given the above and other considerations, the present application is proposed.

One of the fundamental concepts of the present application is to provide a novel serial inspection robot system with an innovative drive design. According to this drive design, a drive chain is installed along the path of the track. a drive motor, a speed reducer, and a drive sprocket of a drive mechanism of the inspection robot system can be assembled together, for example, through a mounting bracket. The inspection robot can be connected to or assembled with it. The drive sprocket engages and rolls on the drive chain, thereby driving them to move along the track. The mounting bracket, such as a mounting seat, can be equipped with guiding/limiting guide wheels. The entire or part of the drive chain in this drive design, such as the drive chain installed in the curved track section, preferably adopts a laterally flexible or three-dimensionally extendable drive chain. This drive chain-sprocket arrangement offers significant advantages over traditional pulley and rail designs and gear and rack transmission designs. The operation of pulley and rail and the path are unstable and basically cannot carry a heavy load; the motion of gear and rack transmission is essentially not capable of achieving two-dimensional and three-dimensional degrees of freedom, let alone the motion from a vertical path to a curved/twisted path and then to a horizontal circumferential path in certain cases. By contrast, the preferred worm gear and worm speed reducer not only saves installation space but also has natural self-locking characteristics, which is important and advantageous for the drive mechanism and inspection robot to maintain their position on the track when needed.

According to another conceptual aspect, the use of a generally closed track with a polygonal cross-section, such as a rectangle, is easier to manufacture and supply, with lower costs and the ability to prevent dust and water accumulation. The additional benefit of this regular-shaped closed track is that in dusty environments such as mines and underground locations, it can prevent dust accumulation in the track groove (if the track is an open grooved track), which would otherwise affect its use. Moreover, the manufacturing and processing costs of the regular-shaped closed track are lower, while its strength and rigidity can be higher.

Another aspect of the present application is to provide a novel cable traction design. According to this traction design, a plurality of traction carriages are installed along the path of the track. The cable is fixed to the traction carriages and driven by the drive mechanism. In this way, it is very convenient to supply power to the drive mechanism and/or the inspection robot, and it also allows the cable to follow the drive mechanism smoothly to move, facilitating the installation and operation of the cable and ensuring the reliability of power supply and cable life. This offers advantages compared to, for example, the existing technology of power supply through a sliding contact line.

A serial inspection robot can be equipped with a plurality of serial robot modules, allowing for a small volume design and explosion-proof design of the robot modules. This is because each module only requires a relatively small-capacity battery to meet explosion-proof standards. Moreover, this design also provides improved maintenance/replacement convenience and high reliability.

More specifically, according to one aspect of the present application, a track assembly for an inspection robot system is disclosed, comprising: a track that defines an inspection path; and a continuous and unbroken drive chain fixedly installed on the track along its extension.

In one embodiment, the inspection robot system includes an integrated inspection robot or a serial inspection robot.

In one embodiment, the track has a generally polygonal cross-section, the shape of which is configured such that the track has a flat bottom surface and a flat top surface, and two side surfaces selected from one of the group consisting of two vertical side surfaces, two inclined upper side surfaces, and two arc-shaped upper side surfaces.

In one embodiment, the cross-section of the track is selected from one of the following: rectangular, trapezoidal, truncated isosceles triangular, pentagonal, hexagonal, and drum-shaped.

In one embodiment, the track is a rectangular track with a generally rectangular cross-section, and a mounting seat of the inspection robot system has two pairs of upper guide wheels and two pairs of lower guide wheels that roll along both sides of the top and bottom surfaces of the rectangular track, respectively.

In one embodiment, the track has a flat bottom surface, a flat top surface, and two inclined or arc-shaped upper side surfaces, and a mounting seat of the inspection robot system has two pairs of upper guide wheels and two pairs of lower guide wheels that roll along the two inclined or arc-shaped upper side surfaces and the bottom surface of the track, respectively.

In one embodiment, the track assembly further includes a mounting seat configured to roll along the track, the mounting seat being equipped with at least two pairs of upper guide wheels, two pairs of lower guide wheels, and a drive mechanism, the drive mechanism including a motor, a speed reducer and a drive sprocket, the drive sprocket being rotatably mounted on the mounting seat and arranged to engage with the drive chain.

In one embodiment, the drive chain is a laterally flexible drive chain.

In one embodiment, the drive chain is fixedly installed on a bottom surface of the track and extends along the track.

In one embodiment, the drive chain is fixedly installed near the centerline of the bottom surface of the track by rivets or screws.

In one embodiment, the drive chain is a single continuous and unbroken chain fixedly installed along the length of the track. The advantage of this single continuous and unbroken chain is that it prevents slippage during the operation of the inspection robot, provides strong climbing ability, and offers more precise positioning.

In one embodiment, the drive chain is composed of at least two sections of chains that are seamlessly spliced and fixed along the length of the track.

In one embodiment, the track is made of an integrally formed aluminum, stainless steel, or carbon steel profile.

A serial inspection robot system is also disclosed, comprising: a track that defines an inspection path; a drive mechanism including a motor, a speed reducer, and a drive sprocket, the rotational motion of the motor being transmitted to the drive sprocket through the speed reducer, thereby driving the drive sprocket to rotate; a plurality of mounting seats, each of the mounting seat being equipped with guide wheels that roll along the track, and the drive mechanism being rotatably mounted on the corresponding mounting seat; a drive chain fixedly installed on and along the extension direction of the track, the drive sprocket engaging with the drive chain, thereby enabling the drive mechanism and the mounting seat to move along the track when the drive sprocket rotates; and a serial inspection robot including a set of robot modules connected in series, each of the robot modules being mounted on the corresponding mounting seat and driven by the drive mechanism to move along the track.

In one embodiment, the robot modules are mounted on the corresponding mounting seats and connected in series through rigid rods with universal joints.

In one embodiment, the number of drive mechanisms is one; or alternatively, the number of drive mechanisms is at least two, the at least two drive mechanisms having the same configuration.

In one embodiment, the serial inspection robot is a wireless-powered serial inspection robot, wherein the drive mechanism is powered by a built-in battery or a separate battery module; the set of robot modules also includes at least one of the following battery-powered functional modules: lighting module, video-thermal imaging-audio module, gas sensor module, intercom module, ground wireless sensor data collection module, fire-fighting module, and video-thermal imaging lens cleaning module.

In one embodiment, the inspection robot system further includes a cable traction assembly, the cable traction assembly comprising: a plurality of traction carriages, each of the traction carriages being installed on the track and running along the longitudinal extension of the track; a cable, one end of which is connected to the drive mechanism and/or the serial inspection robot, and the other end of which is connected to a power supply and a communication gateway; wherein the cable is fixed or clamped on the plurality of traction carriages, thereby allowing the cable to move with the movement of the traction carriages.

In one embodiment, the traction carriage includes a bracket, two pairs of upper guide wheels and two pairs of lower guide wheels installed on the bracket and configured to run on the top and bottom surfaces of the track, respectively.

In one embodiment, the bracket is a U-shaped bracket with a base plate and two side plates, and on each of the side plates, a pair of upper guide wheels and a pair of lower guide wheels are installed in parallel, allowing them to roll along the top and bottom surfaces of the track, respectively.

In one embodiment, the bracket is made of a stainless steel, carbon steel, or aluminum profile.

In one embodiment, the U-shaped bracket also includes a side guide wheel installed between the pair of upper guide wheels and the pair of lower guide wheels on each of the side plates, the side guide wheel being configured to roll along the corresponding side surface of the track.

In one embodiment, the traction carriage shares the track with the mounting seat for rolling movement.

In one embodiment, the drive chain is a toothed chain or a roller chain.

In one embodiment, at least a part of the drive chain is laterally flexible, for example, providing three-dimensional extension freedom.

In one embodiment, the mounting seat includes a lower bracket and two upper bracket parts, each of which is independently pivotable relative to the lower bracket.

In one embodiment, each upper bracket part includes a base plate and two side plates extending upward from the base plate.

In one embodiment, the upper bracket part is an upper U-shaped part, and on each side plate of each upper U-shaped part, an upper guide wheel and a lower guide wheel are installed, the upper guide wheel and the lower guide wheel rolling along the top and bottom surfaces of the track, respectively.

In one embodiment, a side guide wheel is further installed between the upper guide wheel and the lower guide wheel on each side plate of each upper U-shaped part, the side guide wheel being configured to roll along the side surface of the track.

In one embodiment, two pivot holes are provided on the lower bracket, and each upper bracket part is pivotally mounted on the lower bracket through a pivot passing through the corresponding pivot hole.

In one embodiment, a thrust ball bearing is further provided at the lower end of the pivot hole of the lower bracket, with a pivot passing through the thrust ball bearing.

In one embodiment, the drive chain is fixedly installed on the bottom of the track and extend along the track.

In one embodiment, the drive chain is fixedly installed near the centerline of the bottom of the track by rivets or screws.

In one embodiment, the guide wheels are flanged wheels, with each flange surface thereof close to the track being a beveled surface, forming an angle A with a plane perpendicular to the rotational axis of the guide wheel, where 0<A≤30°.

In one embodiment, 5≤A≤20°.

In one embodiment, the guide wheels are flanged wheels, with each flange surface thereof close to the track being a curved surface, the radius of curvature of which is smaller than the curvature radius of the track.

In one embodiment, the speed reducer is a worm gear and worm, with the worm being in driving engagement with the motor shaft, and the worm gear being in driving engagement with the drive sprocket.

In one embodiment, the worm gear is fixed on one side of the lower bracket of the mounting seat, and the drive sprocket is rotatably installed on the opposite side of the lower bracket coaxially with the worm gear.

In one embodiment, as an alternative, the speed reducer is a combination of a planetary gear reducer and a motor brake disc.

In one embodiment, the track has a generally polygonal cross-section, the shape of which is configured such that the track has a flat bottom surface and a flat top surface after installation, and two side surfaces selected from one of the group consisting of two vertical side surfaces, two inclined upper side surfaces, and two arc-shaped upper side surfaces.

In one embodiment, the cross-section of the track is selected from one of the following: rectangular, trapezoidal, truncated isosceles triangular, pentagonal, hexagonal, and drum-shaped.

In one embodiment, the track is a rectangular track with a generally rectangular cross-section, and the upper and lower guide wheels of the mounting seat roll along the top and bottom surfaces of the rectangular track, respectively. A rectangular track is easier to manufacture and supply, and it is more cost-effective.

In one embodiment, the drive chain is a single continuous and unbroken chain fixedly installed along the length of the track.

In one embodiment, the drive chain is composed of at least two sections of chains that are seamlessly spliced and fixed along the length of the track.

In one embodiment, each robot module in the set of robot modules is independently maintainable and/or replaceable.

In one embodiment, at least one robot module in the serial inspection robot is fixedly assembled with the drive mechanism.

In one embodiment, the track is a ring-shaped track, defining a ring-shaped fixed inspection path for the inspection robot.

In one embodiment, at least one robot module in the serial inspection robot is fixedly mounted on the mounting seat.

In one embodiment, the drive sprocket is located below the track and can engage with the drive chain fixedly installed on the bottom surface of the track.

In one embodiment, splicing grooves for installing splicing pins are provided on at least a section of the track.

In one embodiment, the track is an integrally formed metal part.

In one embodiment, the functional modules are powered by an internal battery.

In one embodiment, the functional modules are powered from the cable.

In one embodiment, the track, for example, can be made of metal materials such as stainless steel, carbon steel, or aluminum profile, providing advantages in terms of cost, weather resistance, ease of processing, ease of replacement, and maintainability.

In one embodiment, various robot modules can communicate and be powered through cables, or alternatively they can be battery-powered and communicate wirelessly.

According to another aspect of the present application, a track assembly for an inspection robot system is disclosed, comprising: a track that defines an inspection path; and a continuous and unbroken drive chain fixedly installed on the track along its extension; wherein the drive chain is a laterally flexible drive chain, which is fixedly installed on a bottom surface of the track and extends along the track; wherein the track is selected from one of the following items (i) and (ii): (i) the track has a generally polygonal cross-section, the shape of which is configured such that the track has a flat bottom surface, a flat top surface, and two vertical side surfaces, and wherein the track is configured such that two pairs of upper guide wheels and two pairs of lower guide wheels on a mounting seat of the inspection robot system roll along both sides of the top and bottom surfaces of the track, respectively; and (ii) the track has a flat bottom surface, a flat top surface, and two inclined or arc-shaped upper side surfaces, and wherein the track is configured such that two pairs of upper guide wheels and two pairs of lower guide wheels on a mounting seat of the inspection robot system roll along the two inclined or arc-shaped upper side surfaces and the bottom surface of the track, respectively; wherein each of the upper guide wheels in the items (i) and (ii) is a flanged wheel which has a wheel body with a flange, and a fillet arc is arranged between the flange and the wheel body, and wherein a flange surface of the flanged wheel close to the track is a beveled surface, forming an angle A with a plane perpendicular to a rotational axis of the upper guide wheel, where 2°<A≤20°.

In one embodiment, since the inspection robot adopts a design of robot modules distributed serially along the track, this design avoids concentrated arrangement on the track, thereby providing a distributed light-load configuration. Since the functions and power consumption of the modules are also distributed, the battery capacity on each module can be smaller, with less stress and easier explosion-proof certification. Each module can be independently maintained, repaired, and replaced, so it has better maintainability compared to an integrated inspection robot.

According to one embodiment of the present application, by adopting the meshing transmission between the sprocket and the fixed chain on the track, in combination with a speed reducer in the form of worm gear and worm, many advantages can be provided, such as no slippage, strong climbing ability, self-locking when stopped, stable positioning of the drive mechanism even when subjected to external forces, simple structure, and so on.

The present application also discloses the use of the inspection robot system for inspection in outdoor environments, underground mines, dock transportation sites, industrial production lines, long-distance track conveying sites, long-distance belt conveying sites, explosion-proof sites, frost-proof sites, rain-proof sites, and dust-proof sites.

Further embodiments of the present application may achieve other beneficial technical effects not listed individually, which may be partially described herein below and which are apparent and understood by a person skilled in the art after reading the present application.

### BRIEF DESCRIPTION OF THE DRAWINGS

The above-mentioned features and advantages of these embodiments, as well as other features and advantages and the ways in which they are achieved, will become more apparent through reference to the following description in conjunction with the drawings, and the embodiments of the present application can be better understood.

FIG. 1A is a schematic view of the main configuration of a wireless-powered (battery-powered) serial inspection robot system according to one embodiment of the present application, showing the overall layout of an exemplary inspection robot system arranged on a ring-shaped track.

FIG. 1B is a schematic view of the main configuration of a wired (cable-powered) serial inspection robot system according to one embodiment of the present application, showing the overall layout of the inspection robot system.

FIG. 2A is an enlarged schematic view of a part of the wireless-powered (battery-powered) inspection robot system shown in FIG. 1A, showing an enlarged view of the arrangement of the serial inspection robots (modules) and drive mechanism on the track.

FIG. 2B is an enlarged schematic view of a part of the wired (cable-powered) inspection robot system shown in FIG. 1B, showing an enlarged view of the arrangement of the serial inspection robots (modules) and drive mechanism on the track.

FIG. 3 is a further enlarged view of the wired-powered inspection robot module, drive mechanism, and traction carriage shown in FIG. 2B.

FIG. 4 is a further enlarged schematic perspective view of the wireless-powered (battery-powered) inspection robot system shown in FIG. 2A, showing the drive mechanism and a part of the track (curved section).

FIG. 5 is a further enlarged partial view of the structure shown in FIG. 2B from another perspective, and a partial section is made to show the track with a rectangular cross-section.

FIG. 6 is an enlarged schematic view of the drive mechanism and inspection robot (module) of a serial inspection robot system according to one embodiment of the present application.

FIG. 7 is an enlarged schematic view of the drive mechanism and inspection robot module assembled together through the mounting seat shown in FIG. 6, in a partially sectioned form.

FIG. 8 schematically shows the drive mechanism, inspection robot (module), and mounting seat structures shown in FIG. 6 from another perspective.

FIG. 9 shows the construction of the drive mechanism shown in FIG. 8, with the inspection robot module removed, and illustrates the two upper U-shaped parts of the mounting seat each independently pivotable relative to the lower part.

FIG. 10 is a partial perspective view of the drive mechanism shown in FIGS. 8-9, particularly and schematically showing the guide wheels and the pivoting design of the mounting seat.

FIG. 11 is a partial perspective view of another embodiment of the drive mechanism, which is essentially the same as the structure shown in FIG. 10, except for the addition of side guide wheels on the mounting seat.

FIG. 12 shows a track with a rectangular cross-section according to one embodiment of the present application, which can be equipped with an electric heating device.

FIG. 13 shows the arrangement and design of the guide wheels of the mounting seat according to one embodiment of the present application, particularly showing the flange on the guide wheel and the beveled surface design of the flange for easy passage through curved sections.

FIG. 14 is an enlarged view of the guide wheel construction according to one embodiment of the present application, particularly showing the flange on the wheel body and the beveled surface design of the flange.

FIG. 15 shows an enlarged schematic perspective view of one embodiment of the traction carriage, showing the construction and details of the traction carriage of this embodiment.

### DETAILED DESCRIPTION

In the following description of the drawings and specific modes of implementation, the details of one or more embodiments of the present application will be set forth. From these descriptions, drawings, and claims, the other features, objectives and advantages of the embodiments of the present application can be clearly understood.

It should be understood that the embodiments illustrated and described are not limited to the details of the construction and arrangement of the components as described below. The illustrated embodiments can be other embodiments that can be implemented or carried out in various ways. The examples provided are for the purpose of explaining the disclosed embodiments rather than being limitative. In fact, it will be apparent to those skilled in the art that various modifications and variations can be made to the embodiments of the present application without departing from the scope or spirit of the disclosed application. For example, features illustrated or described as part of one embodiment can be used in another embodiment to form another embodiment. Therefore, the disclosed application covers such modifications and variations that fall within the scope of the appended claims and their equivalents.

In existing inspection robot solutions, in application scenarios where the operating channel of the inspection robot conveyor chain is relatively narrow, the monolithic design of the inspection robot may be unable to pass through the narrow operating channel due to its large overall size, thereby limiting or obstructing the applications of the inspection robot system.

In addition, the inspection robot needs to work uninterruptedly for a long time, and its working environment may be relatively harsh, such as high-temperature, high-humidity, high-dust environments, etc. In such cases, the monolithic design of the inspection robot may cause a series of problems due to its integral structure, such as centralized heat generation of each working module, leading to heat dissipation issues. These may not meet the explosion-proof requirements and reliability for certain applications. Moreover, if one component in the above monolithic overall structure fails, the entire inspection robot conveyor chain must be stopped, and the entire inspection robot must be removed for replacement or diagnostic repair, which may lead to an unacceptable loss of long-term, low-failure operation of the inspection robot conveyor chain in application scenarios.

The following is further detailed description and explanation of the present application in combination with the drawings and specific embodiments.

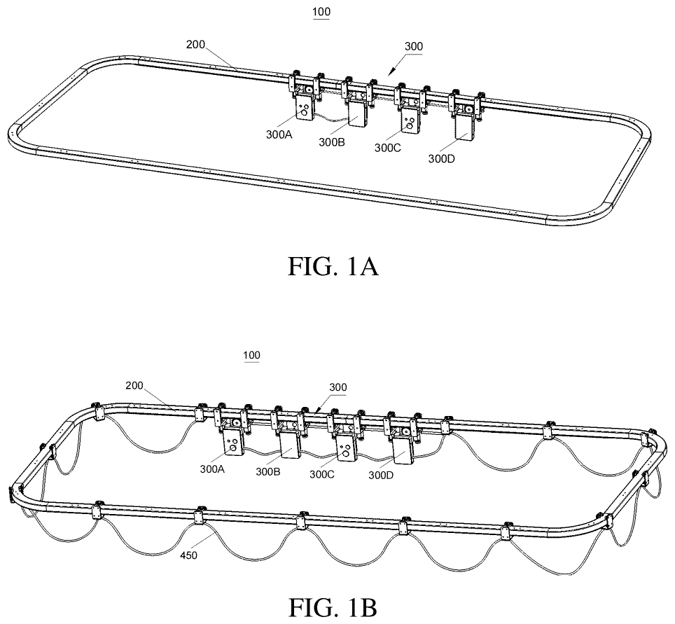

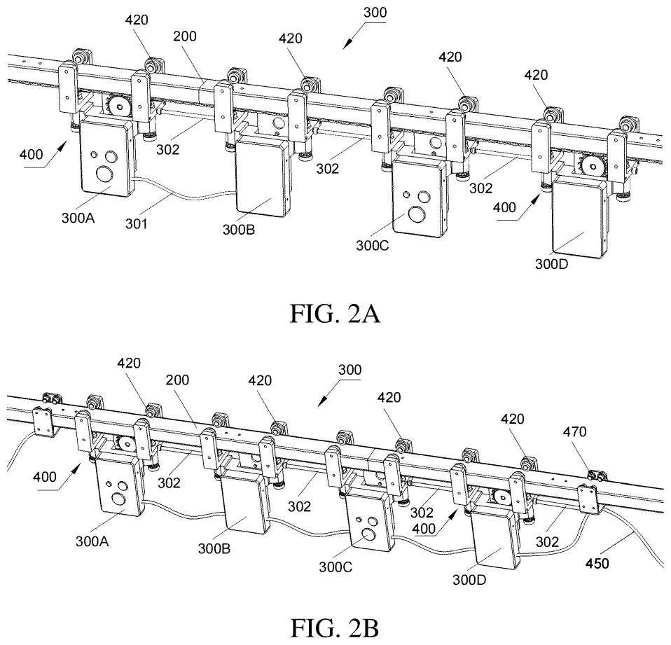

FIG. 1A is a schematic view of the main configuration of a wireless-powered (battery-powered) serial inspection robot system 100 according to one embodiment of the present application, showing the overall layout of the inspection robot system 100 arranged on an exemplary ring-shaped track 200. FIG. 2A is an enlarged schematic view of a part of the wireless-powered (battery-powered) inspection robot system 100 shown in FIG. 1A, showing an enlarged view of the arrangement of the serial inspection robots (modules) 300 and drive mechanism 400 on the track 200. FIG. 4 is a further enlarged schematic perspective view of the wireless-powered (battery-powered) inspection robot system 100 shown in FIG. 2A, showing the drive mechanism 400 and a part of the track (curved section).

As shown in FIGS. 1A, 2A, and 4, the basic components and overall layout of the wireless-powered (battery-powered) serial inspection robot system 100 are illustrated. The serial inspection robot 300 of the inspection robot system 100 can move along the track under the drive of the drive mechanism 400 with the drive sprocket 440 engaging with the drive chain 240 fixed on the track 200, to inspect the surrounding environment.

As shown in FIG. 2A, an exemplary serial inspection robot 300 is shown, which includes a set of four serially arranged inspection robot modules 300A-300D. This set of robot modules 300A-300D is serially arranged on the track 200 with intervals as shown in the figure. One end of the robot module 300D is mounted with a drive motor 410 and driven by it, and the other end of the robot module 300A is also mounted with a drive motor 410 and driven by it. These robot modules may be connected to each other through rigid rods such as steel rods 302 or steel wires 302, thereby being driven to move together along the track 200. In the case of using rigid rods such as steel rods 302, universal joints can be added to both ends to provide flexibility and passability when going around curved sections. Additionally, in the case of battery-powered design, at least one robot module, for example, robot module 300B, can be a battery module, which can supply power to the inspection robot module 300A and its drive mechanism 400 through wires or cables 301. In the embodiment shown in FIG. 2A, drive mechanisms 400 with motors and transmission and speed reduction devices are provided at head end and tail end, that is, at the positions of the inspection robot modules 300A and 300D. Of course, it is also possible to equip a serial inspection robot with one or more drive mechanisms 400. The inspection robot modules 300A-300D can be wirelessly connected for communication. The drive motor 410, for example, can be in the form of a servo motor.

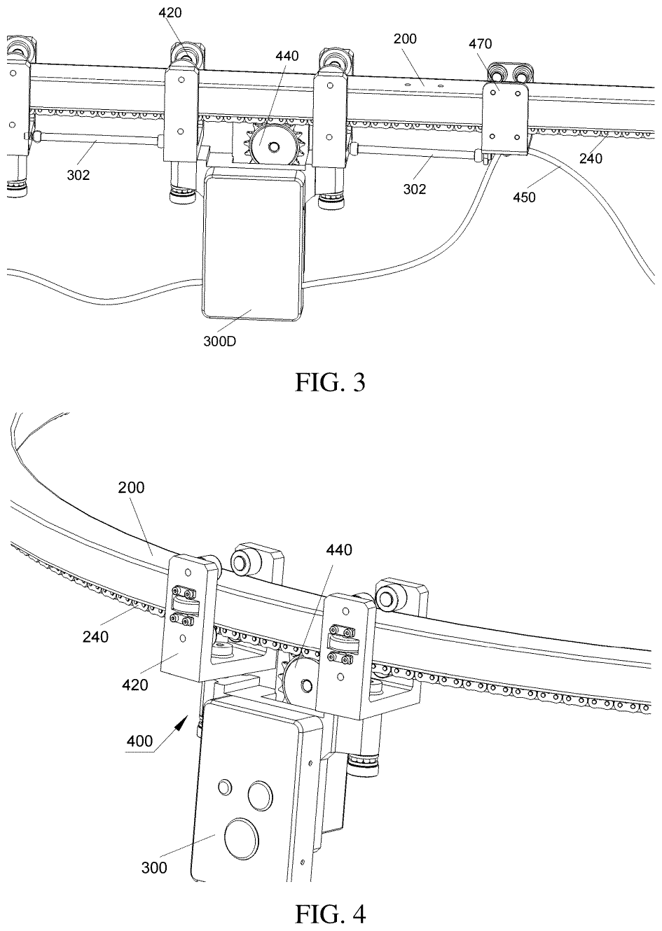

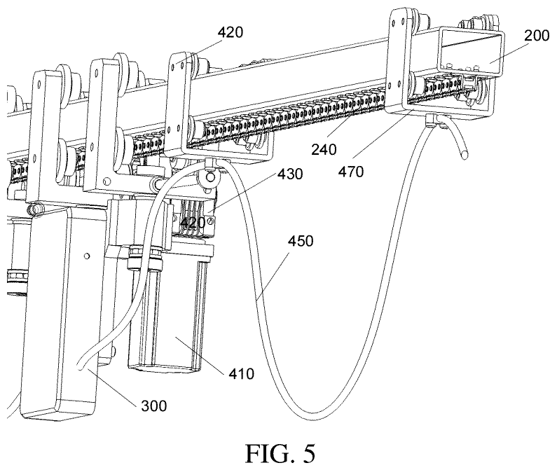

FIG. 1B is a schematic view of the main configuration of a wired (cable-powered) serial inspection robot system 100 according to one embodiment of the present application, showing the overall layout of the inspection robot system 100. FIG. 2B is an enlarged schematic view of a part of the wired (cable-powered) inspection robot system 100 shown in FIG. 1B, showing an enlarged view of the arrangement of the serial inspection robots (modules) 300 and drive mechanism 400 on the track 200. FIG. 3 is a further enlarged view of the wired-powered inspection robot module 300D, drive mechanism 400, and traction carriages shown in FIG. 2B. FIG. 5 is a further enlarged partial view of the structure shown in FIG. 2B from another perspective, and a partial section is made to show the track with a rectangular cross-section. The embodiment of the wired-powered serial inspection robot system 100 is similar in configuration and construction to the wireless-powered serial inspection robot system shown in FIGS. 1A and 2A, with the main difference being that the set of four serially arranged inspection robot modules 300A-300D in this wired-powered serial inspection robot system 100 is powered externally through a cable 450, so a separate battery module can be omitted if necessary. Additionally, communication (if any) between the inspection robot modules 300A-300D can also be in a wired form, although this is not mandatory. The cable 450 is connected to the drive mechanism and/or the inspection robot (module) and can follow the inspection robot (module) 300 along the track 200 through the traction of the traction carriage 470, as described below. Wired power supply and communication are advantageous in short-distance inspection scenarios and can provide a more reliable power supply and communication method.

As shown in FIG. 3, the robot module 300D at one end is connected to the traction carriage 470 that carries the cable 450 (for example, by clamping or other mounting methods). Those skilled in the art can understand that since the inspection robot is not very heavy and the track 200 is mainly horizontally extended in most cases, the traction carriage does not need to be equipped with a separate tow rope, which can be omitted in the inspection robot scenario. That is to say, the traction carriage 470 can simply be connected (and electrically connected) to the drive mechanism 400 through the power supply cable and/or communication cable 450, and/or connected (and electrically connected) to the inspection robot (for example, module 300D shown in FIG. 3), so that the power supply cable 450 can follow the drive mechanism 400 along the track 200. In comparison, some existing inspection robots also use cable for power supply, but generally use the sliding contact line arrangement. One technical defect of the sliding contact line, among others, is that it is prone to poor contact, or short circuit when encountering a humid environment, and the reliability of power supply through the sliding contact line is relatively low. This cable traction method of the present application can alleviate or avoid the above defects.

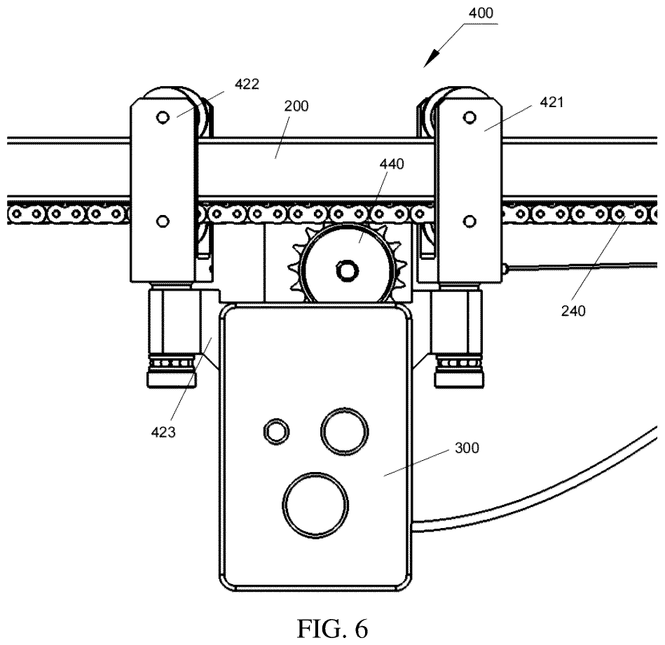

FIG. 5 is a further enlarged partial view of the structure shown in FIG. 2B from another perspective, and a partial section is made to show the track with a rectangular cross-section. FIG. 6 is a schematic view of the drive mechanism 400 and the inspection robot (one robot module) 300 installed and operating on the track 200 according to one embodiment of the present application.

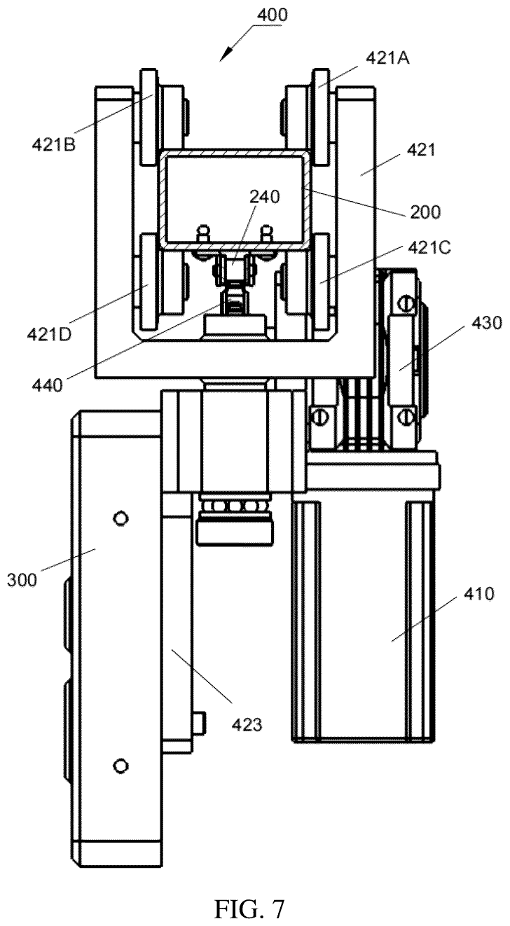

FIG. 7 shows a partially sectioned end view of the installation of the drive mechanism 400 on the rectangular track 200, as well as an exemplary assembly construction of the drive chain 240. As shown in the figure, the track 200 has a generally rectangular cross-section, but other forms of construction and cross-sections of the track 200 are also possible. For example, the track 200 can have a generally polygonal cross-section, the shape of which is configured such that the track 200 has a flat bottom and top surface after installation, and either two vertical side surfaces, or two inclined upper side surfaces (or two arc-shaped upper side surfaces). The cross-section of the track 200 can be rectangle, trapezoidal, isosceles trapezoidal, pentagonal, hexagonal, drum-shaped, etc. The track 200, for example, can be integrally formed from metals such as aluminum, aluminum alloy, steel, etc. Generally speaking, a rectangular track is easier to manufacture and supply, and the cost can be lower.

Additionally and importantly, as shown in FIGS. 5 and 7-10, in the orientation shown in FIG. 7, on the track 200, for example, near the centerline of the bottom surface of the track 200 or other positions, the drive chain 240 can be fixedly installed through riveting, screwing, bolting, or other connection methods. The drive chain 240 is arranged along a part or the entire extension length and direction of the track 200 and needs to be fixedly installed on the track 200 in the present application to engage with the sprocket 440 and move along the drive chain 240. FIGS. 5 and 7 also show the motor 410 and speed reducer 430 assembled on the mounting seat 420 of the drive mechanism 400, and the inspection robot 300 which for example can be installed on the opposite side of the motor 410. The speed reducer 430, for example, is preferably but not limited to a worm gear mechanism, as further described in detail below.

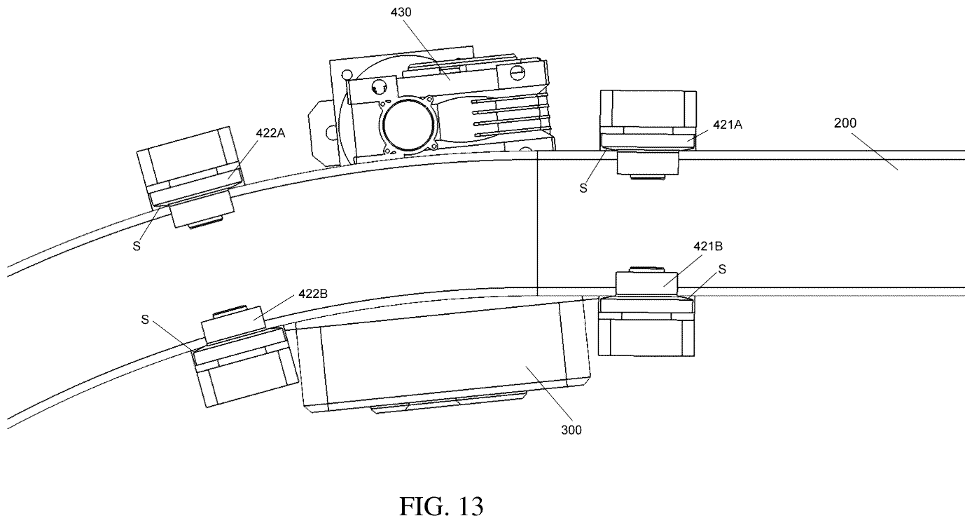

In certain outdoor or cold and icy application environments, the track 200 of the serial inspection robot system of the present application may become icy due to exposure to rain and cold, thereby affecting the normal use of the track 200. Therefore, as shown in FIG. 12, an electric heat strip installation groove 260 can also be provided in the track 200, which can accommodate an electric heating element 250, such as an electric heat strip, electric heat wire, or PTC thermistor, for heating the track, deicing, and/or removing water. Although FIG. 12 shows the electric heating elements 250 installed on both side surfaces, the number and arrangement of the electric heating elements 250 can be varied according to needs, for example, more or fewer, and they can be installed on any construction of the track 200, not limited to the rectangular track.

Another advantage of the regular-shaped closed track, such as the rectangular track 200, is that in dusty environments such as mines and underground locations, it can prevent dust accumulation in the track groove (if the track is an open grooved track), which would otherwise affect its use. Moreover, the manufacturing and processing costs of the regular-shaped closed track are lower, while its strength and rigidity can be higher.

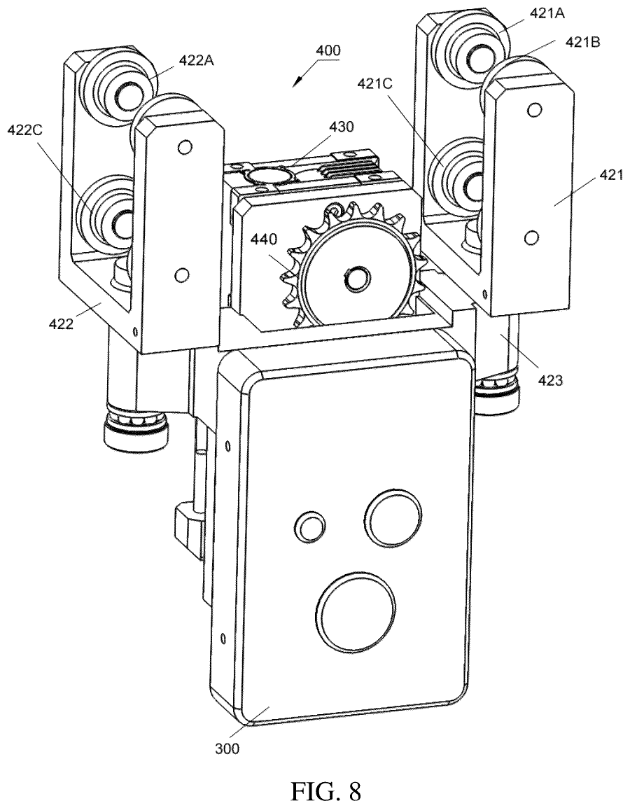

FIG. 6 is an enlarged schematic view of the drive mechanism 400 and the inspection robot 300 of the serial inspection robot system according to one embodiment of the present application. FIG. 7 shows a partially sectioned end view of the structure shown in FIG. 6. FIGS. 8-10 show the construction of the drive mechanism, the inspection robot (module), and the mounting seat, in one embodiment. As shown in FIGS. 6-10, the drive mechanism 400 in this embodiment includes a motor 410, a speed reducer 430, and a drive sprocket 440. As an exemplary example, the speed reducer 430 mainly consists of a worm gear and worm that are in meshing engagement. This worm gear and worm form of speed reducer 430 not only effectively reduces speed but also has a self-locking characteristics, which is convenient for fixing the inspection robot (module) on the track and is not easily possessed by other forms of speed reducers. The motor shaft of the motor 410 can be coaxially connected to the worm to transmit the rotational motion from the motor, and the rotational motion, after being decelerated by the meshing worm gear, is transmitted to the drive sprocket 440. As shown in FIG. 7, the worm gear-worm type speed reducer 430 is installed on the right side of the mounting seat 420 as shown in the figure, and on the left side of the mounting seat 420, the drive sprocket 440 can be installed in a coaxial manner. In this way, through the mounting seat 420, the inspection robot (module) 300 and the drive mechanism 400 are assembled into one integral unit. The drive sprocket 440 meshes with the drive chain 240 fixed on the track, as shown in FIG. 7. In this way, when the drive sprocket 440 of the drive mechanism 400 is driven by the motor 410 to rotate, it can mesh with the drive chain 240 fixed on the track 200 and thus roll along the track 200, for example, rolling forward or backward, thereby driving the entire drive mechanism 400, mounting seat 420, and inspection robot 300 to move along the track 200.

The drive chain 240 can be a roller chain. Of course, the drive chain 240 can also be another form that is suitable for meshing with the drive sprocket, such as a toothed chain. Since the drive chain 240 needs to extend upward in a generally vertical direction, extend horizontally along the circumferential direction, and may need to laterally bend and/or twist, it is preferable that at least a part or all of the drive chain 240 is a laterally flexible drive chain, which can have the freedom to extend in three- dimensional space.

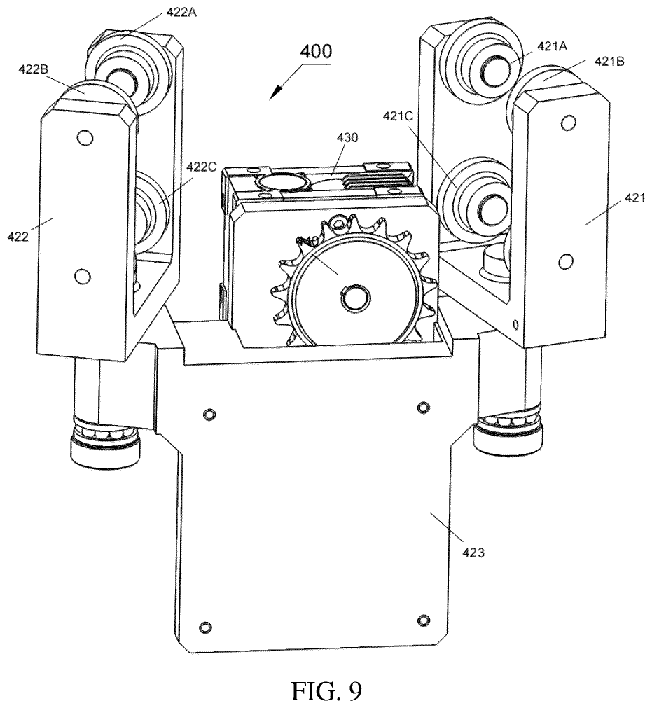

To facilitate the smooth and stable movement of the entire drive mechanism 400 and the inspection robot 300 along the track 200, as shown in FIGS. 8-10, according to one embodiment, the mounting seat 420 can include a lower bracket 423, and two upper bracket parts 421 and 422, for example, in the shape of a generally U-shape, each of which can independently pivot relative to the lower bracket 423. For example, the upper U-shaped part 421 or 422 can independently pivot relative to the lower bracket 423 from the orientation shown in FIG. 8 to the orientation shown in FIG. 9. In this way, the mounting seat 420 can be flexibly and easily adjustable when going around curved sections on the track, allowing for smooth passage through the curved sections.

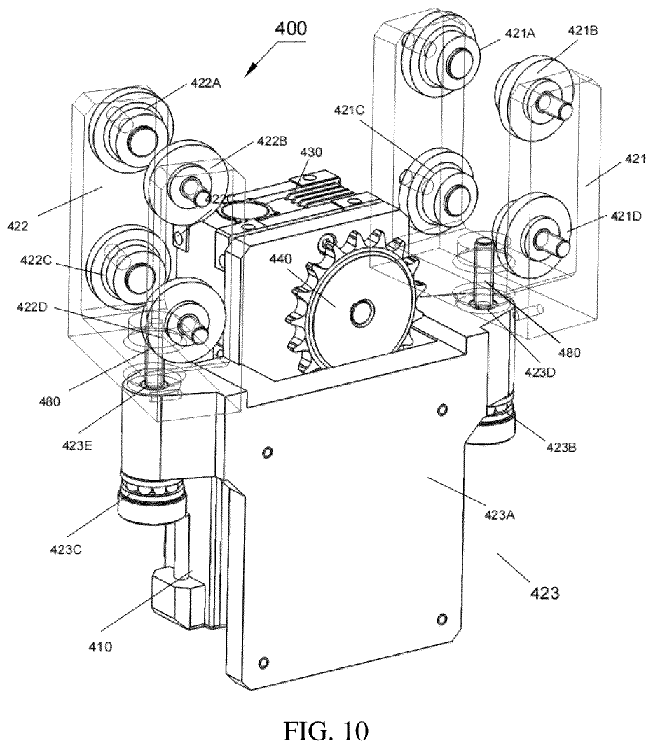

Each upper U-shaped part 421 and 422 includes a base plate and two side plates extending upward from the base plate. As shown in FIG. 10, an upper guide wheel 421A and a lower guide wheel 421C are installed on one side plate of the upper U-shaped part 421, and an upper guide wheel 421B and a lower guide wheel 421D are installed on the opposite side plate. A pivot 480 is installed on the base plate of the upper U-shaped part 421, as described in detail below. Similarly, an upper guide wheel 422A and a lower guide wheel 422C are installed on one side plate of the upper U-shaped part 422, and an upper guide wheel 422B and a lower guide wheel 422D are installed on the opposite side plate. Another pivot 480 is installed on the base plate of the upper U-shaped part 422, as described in detail below. These upper and lower guide wheels are configured to roll along the top and bottom surfaces of the track 200 to guide the movement, limit the position, align the direction, and to prevent jumping during operation. The presence of these guide wheels helps the drive mechanism 400 and the inspection robot 300 to move smoothly along the track 200 and prevents jumping, derailment, and track deviation during operation.

As shown in FIGS. 5-10, a flat plate 423A can be designed on the lower bracket 423, on which the inspection robot (module) 300, such as camera module, battery module, drive module, video-audio module, sensor module, etc., or other inspection equipment, can be installed. The lower bracket 423 also has two pivot holes 423D and 423E corresponding to the base plates of the two upper U-shaped parts 421 and 422. These two pivot holes 423D and 423E, as shown in the Figures, can be intentionally thickened to allow two pivots 480 of a certain length to pass through, as shown in FIG. 10. One end of these two pivots 480, for example, can be fixed to the corresponding upper U-shaped part's base plate, for example, by screw threads in the two pivot holes 423D and 423E, or/and can be fixed with a nut or screw cap. The other end of these two pivots 480 can be pivotally mounted on the lower bracket 423. For example, the end flange of this other end can be in contact with the end face of the corresponding pivot hole, thereby enabling the upper U-shaped part to pivot relative to the lower bracket. As an preferred example, a thrust ball bearing 423B and 423C can be provided between the end flange of this other end and the corresponding pivot holes 423D and 423E, thereby ensuring the accurate and reliable mount of the two upper U-shaped parts 421 and 422 relative to the lower bracket 423, and ensuring that the two upper U-shaped parts 421 and 422 can pivot independently and smoothly relative to the lower bracket 423.

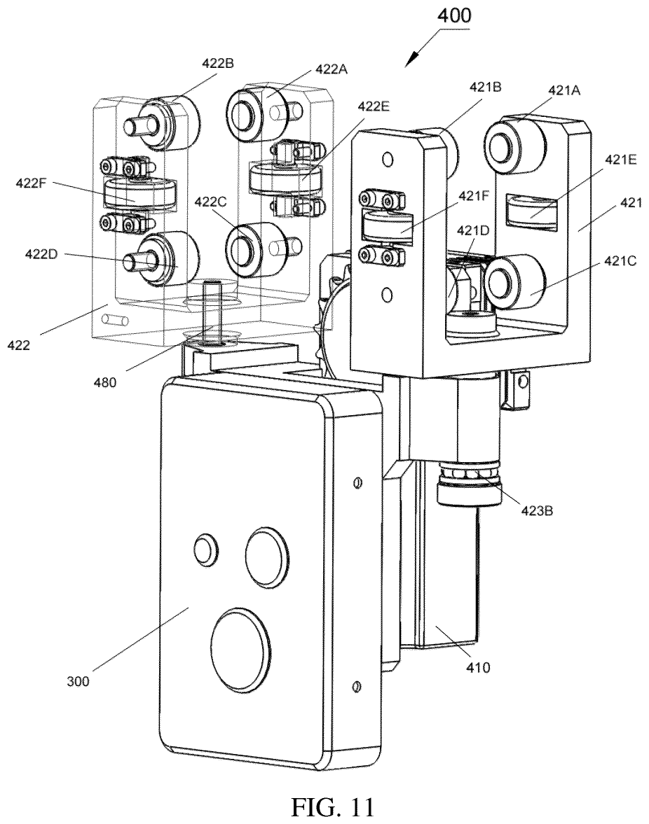

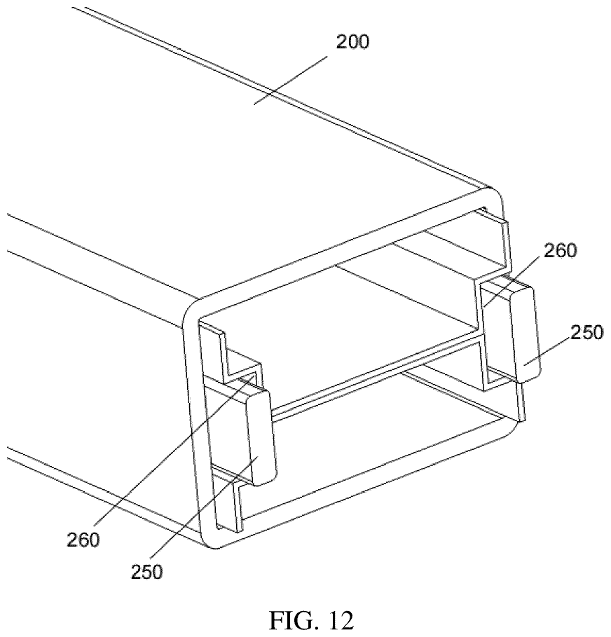

FIG. 11 is a partial perspective view of another embodiment of the drive mechanism 400, which is essentially the same as the structure shown in FIG. 10, except for the addition of side guide wheels on the mounting seat. A side guide wheel is added to each side plate of the upper U-shaped parts 421 and 422, namely 421E, 421F, 422E, and 422F. These side guide wheels 421E, 421F, 422E, and 422F roll along the left and right side surfaces of the track after the drive mechanism 400 is installed on the track 200, further serving to guide the movement, limit the position (left and right), align the direction, and prevent derailment, and of course, they can also further help for smooth passage of curved sections.

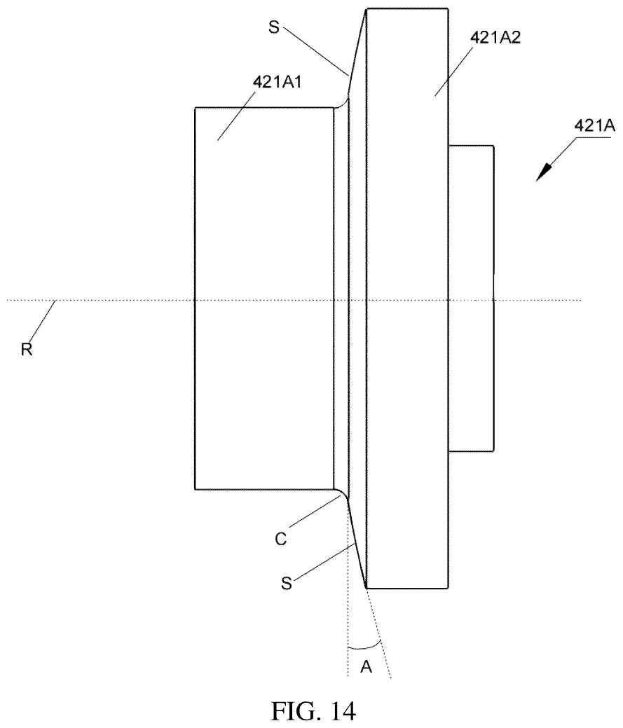

FIGS. 13-14 show a design of the guide wheels that helps to pass through curved sections on the track. As shown in FIGS. 13-14, taking the upper guide wheel 421A of the mounting seat 420 as an example for illustration. The upper guide wheel 421A may have a wheel body 421A1 that rolls on the track 200, and an integral flange 421A2. A fillet arc, such as an inwardly concave arc C, can be used between the flange 421A2 and the wheel body 421A1 to transition, to avoid stress concentration and to more or less help to pass through curved section. Preferably, the end surface of the flange 421A2 facing the track after installation is designed as a beveled surface S, which forms an angle A with a plane perpendicular to the rotation axis R of the guide wheel, where 0<A≤30°, for example, preferably 2≤A≤20°, and more preferably 5≤≤A≤15°, etc. When the end surface of the flange 421A2 facing the track 200 after installation is designed as a curved surface, especially an outwardly bowed curved surface, the radius of curvature of this curved surface is preferably smaller than the curvature radius of the track to help passage through curved section. FIG. 13 shows the situation of the upper guide wheel with the beveled surface S design passing through the curved section. It can be seen that, especially on the inner side of the track curved section, the beveled surface S design greatly reduces or even avoids the interference/obstruction of the track 200 side surface with the rolling of the guide wheel. Although FIGS. 13-14 only show the design of the upper guide wheel of the mounting seat, the lower guide wheel of the mounting seat can also adopt this beveled surface or curved surface design. Similarly, the upper and lower guide wheels of the traction carriage 470 can also adopt this beveled surface or curved surface design for passage through curved sections, which is easily understood by those skilled in the art.

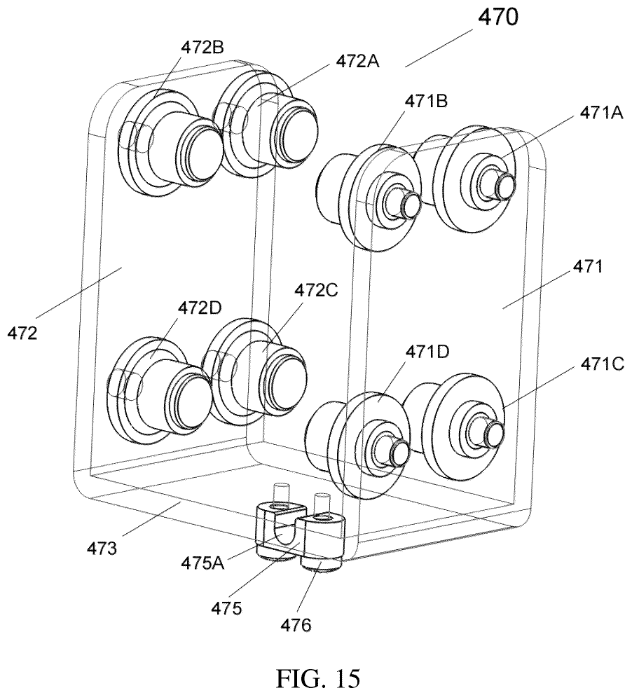

FIG. 15 shows one embodiment of a traction carriage 470 that can roll along the inspection track 200. The traction carriage 470 can be fixed with the cable 450, and the cable 450 can be used directly as a tow rope, without the need for an additional tow rope. This is because, in most cases, the track 200 is a horizontal track, and the traction force/tension on the cable 450 during the towing process is small enough and will not adversely affect the life of the cable 450 and the reliability of power supply.

FIG. 15 is an enlarged schematic perspective view of one embodiment of the traction carriage 470, showing the construction and details of this embodiment of the traction carriage 470. Similar to the arrangement of guide wheels on the mounting seat 420, in this embodiment, the traction carriage 470 has a generally U-shaped bracket made up of a base plate and two side plates extending upward from the base plate, which can be processed from a channel steel (or aluminum alloy) or an I-beam (or aluminum alloy profile). A total of eight guide wheels are installed on this U-shaped bracket. Among them, on one side plate 471 of the traction carriage 470, a pair of upper guide wheels 471A and 471B and a pair of lower guide wheels 471C and 471D are installed, all of which can serve to guide the movement, limit the position, and align the direction. On the other side plate 472 of the traction carriage 470, a pair of upper guide wheels 472A and 472B and a pair of lower guide wheels 472C and 472D can be installed, all of which can also serve to guide the movement, limit the position, align the direction, and prevent jumping during operation. These guide wheels can help the traction carriage 470 roll smoothly along the track 200, so that when the inspection robot 300 and the drive mechanism 400 move along the track 200, the (power supply and/or communication use) cable 450 can be used as a tow rope and can also be carried by the traction carriage 470 to move along the track 200, providing safe and reliable power supply and/or communication. The upper and lower guide wheels of the traction carriage 470 can have the same construction and design as the upper and lower guide wheels of the mounting seat 420, because they can share the track 200 for operation.

On the traction carriage 470, for example, on its base plate 473, a cable mounting member 475 can also be provided, which can include a main body with a groove 475A for accommodating and installing the cable 450, and two fastening screws 476, for example, to secure the cable 450 in the groove 475A. Of course, those skilled in the art can understand that the traction carriage can adopt other forms different from those shown in the figure, as long as it can install and fix the tow rope and cable, all of which are within the scope of the present application.

The track 200, for example, can be integrally formed from metals such as aluminum, aluminum alloy by extrusion process.

The drive chain 240 can be a roller chain or a toothed chain, which can be load-bearing or non-load-bearing in design. Of course, the drive chain 240 can also be another form that is suitable for meshing with the drive sprocket, such as a toothed chain. In locations where slopes and/or bends are needed, the drive chain 240 may also need to laterally bend and/or twist, so in these positions the drive chain 240 can use a laterally flexible drive chain, which preferably has three-dimensional freedom, thereby having the freedom to extend in three dimensions.

Each track 200 can be equipped with one or more serial inspection robots 300. Each serial inspection robot 300 can include a set of a plurality of serially arranged inspection robot modules, such as modules 300A-300D. Although a set of four inspection robot modules is shown in the figure, the number of these modules can be less or more, such as 2, 3, 5, 6, etc., depending on the needs.

Although the modules shown in FIGS. 2A-2B are spaced apart by a certain gap, they can also be serially arranged on the track 200 with little or no gap. Although two motors 410 are shown at both head end and tail end in FIGS. 2A-2B, the number of motors can be one or more, and their positions can also be other arrangements.

By distributing the serially connected inspection robot modules along the track 200, the weight and stress at each installation point are actually reduced, and the weight is distributed over a plurality of points rather than at single point as usual. Through this configuration, potential problems caused by uneven weight-distribution and unbalanced center of gravity of the previous inspection robot can be alleviated or even solved, such as reducing impact, reducing noise and other similar faults during operation, and relatively lower frequency of maintenance and maintenance can be achieved.

Not only that, the volume and space occupied by each inspection robot module can be smaller, so it is possible to apply in scenarios where the operating channel of the inspection robot conveyor chain is relatively narrow. In addition, by deploying and distributing a plurality of inspection robot modules that may generate heat during operation in a serial manner, battery-powered inspection robot modules, for example, can use relatively smaller capacity batteries with better explosion-proof performance when powered by their own batteries, and can also solve the problem of poor heat dissipation, improving the system's operational reliability and robustness. Since the modules are serially distributed and independently self-standing, the difficulty of fault diagnosis and maintenance, repair, and replacement is further reduced. These advantages are more important and prominent in application environments with harsh conditions such as high temperature, high explosion risk, and high dust.

The robot modules of the serial inspection robot can be selected from at least one of the following functional modules: lighting module, video-thermal imaging-audio module, gas sensor module, battery module, intercom module, wireless communication module, fire-fighting module, camera cleaning module. For example, the lighting module can serve as environmental lighting and visual monitoring functions, which usually are basic and necessary for remote monitoring. The video-thermal imaging-audio module can be used to capture images, thermal imaging, and audio information, including photography, thermal imaging, temperature sensing, and recording, etc., and can selectively transmit them in real-time to a ground base station. The fire-fighting module can include relevant sensors, such as temperature sensors, smoke sensors, etc., and can send corresponding warning signals, as well as selectively send corresponding instructions to activate fire-fighting facilities, such as fire hydrants, fire extinguishers, etc. The camera cleaning module can be used to clean the camera of the inspection robot, for example, equipped with a water spray nozzle and a water tank to spray and clean the camera, etc. Of course, those skilled in the art can fully understand that, according to different application scenarios and functions, other functional modules can also be additionally or alternatively added to the serial inspection robot assemblies under the concept of the present application, all of which are within the scope of the present application.

According to one example, a set of robot modules can include a master module and at least one slave module, with the master module being in wireless or wired communication connection with the at least one slave module.

According to one example, the functional modules can have built-in rechargeable batteries as the working power source, so that the modules can operate independently in a self-supporting manner and have better explosion-proof performance. In one example, for the convenience of maintenance, repair, and replacement, these functional modules are capable of independent maintenance and/or independent replacement.

In one example, the wireless communication module can act as the master module. The wireless communication module can be selected from at least one of the following: Zigbee module, WiFi module, Bluetooth module, LoRa transmission module, NB transmission module, Proprietary transmission module, Thread transmission module, Wi-SUN transmission module, Z-Wave transmission module, and infrared communication module.

The above serial track inspection robot system and its various components can be used for inspection, in environments such as underground mines, dock transportation sites, industrial production lines, long-distance track conveying sites, long-distance belt conveying sites, or explosion-proof sites, as well as in other harsh or dangerous working conditions.

In one example, the serial inspection robot system can include online monitoring wireless sensors, which are fixed in the environment along the inspection path to collect status data of the equipment in the environment.

The serial inspection robot system may include an inspection robot with a wireless sensor data communication module, which is configured to communicate wirelessly with the online monitoring wireless sensors during inspection to collect the data acquired by the online monitoring wireless sensors and to send instructions to the online monitoring wireless sensors.

Although the inspection robot in the above embodiments of the serial inspection robot system adopts a serial inspection robot, which can realize many relevant technical advantages, those skilled in the art can understand and easily conceive that when necessary, the serial inspection robot system of the present application can also use an integral inspection robot instead.

According to one example, the functional modules can be powered by a power supply cable, or alternatively, the functional modules can have built-in batteries as the power source.

The above description of the basic concept of the present application is provided in conjunction with the embodiments. It should be noted that the above is only for the description of exemplary embodiments and the technical concept. Those skilled in the art will understand that the present application is not limited to the specific embodiments described herein. Various obvious modifications, readjustments, combinations, and substitutions can be made by those skilled in the art without departing from the scope of protection of the present application. The scope of the present application is determined by the claims.

What is claimed is:

1. A track assembly for an inspection robot system, comprising:
a track that defines an inspection path; and
a continuous and unbroken drive chain fixedly installed on the track along its extension.

2. The track assembly of claim 1, wherein the inspection robot system includes an integrated inspection robot or a serial inspection robot.

3. The track assembly of claim 1, wherein the track has a generally polygonal cross-section, the shape of which is configured such that the track has a flat bottom surface and a flat top surface, and two side surfaces selected from one of the group consisting of two vertical side surfaces, two inclined upper side surfaces, and two arc-shaped upper side surfaces.

4. The track assembly of claim 3, wherein the cross-section of the track is selected from one of the following: rectangular, trapezoidal, truncated isosceles triangular, pentagonal, hexagonal, and drum-shaped.

5. The track assembly of claim 4, wherein the track is a rectangular track with a generally rectangular cross-section, and a mounting seat of the inspection robot system has two pairs of upper guide wheels and two pairs of lower guide wheels that roll along both sides of the top and bottom surfaces of the rectangular track, respectively.

6. The track assembly of claim 3, wherein the track has a flat bottom surface, a flat top surface, and two inclined or arc-shaped upper side surfaces, and a mounting seat of the inspection robot system has two pairs of upper guide wheels and two pairs of lower guide wheels that roll along the two inclined or arc-shaped upper side surfaces and the bottom surface of the track, respectively.

7. The track assembly of claim 1, wherein the track assembly further includes a mounting seat configured to roll along the track, the mounting seat being equipped with at least two pairs of upper guide wheels, two pairs of lower guide wheels, and a drive mechanism, the drive mechanism including a motor, a speed reducer and a drive sprocket, the drive sprocket being rotatably mounted on the mounting seat and arranged to engage with the drive chain.

8. The track assembly of claim 1, wherein the drive chain is a laterally flexible drive chain.

9. The track assembly of claim 1, wherein the drive chain is fixedly installed on a bottom surface of the track and extends along the track.

10. The track assembly of claim 9, wherein the drive chain is fixedly installed near the centerline of the bottom surface of the track by rivets or screws.

11. The track assembly of claim 1, wherein the drive chain is a single continuous and unbroken chain fixedly installed along the length of the track.

12. The track assembly of claim 1, wherein the drive chain is composed of at least two sections of chains that are seamlessly spliced and fixed along the length of the track.

13. The track assembly of claim 1, wherein the track is made of an integrally formed aluminum, stainless steel, or carbon steel profile.

14. An inspection robot system, comprising the track assembly of claim 1.

15. The inspection robot system of claim 14, wherein the inspection robot system includes an integrated inspection robot or a serial inspection robot.

16. A track assembly for an inspection robot system, comprising:
a track that defines an inspection path; and
a continuous and unbroken drive chain fixedly installed on the track along its extension;
wherein the drive chain is a laterally flexible drive chain, which is fixedly installed on a bottom surface of the track and extends along the track; and
wherein the track is selected from one of the following items (i) and (ii):
(i) the track has a generally polygonal cross-section, the shape of which is configured such that the track has a flat bottom surface, a flat top surface, and two vertical side surfaces, and wherein the track is configured such that two pairs of upper guide wheels and two pairs of lower guide wheels on a mounting seat of the inspection robot system roll along both sides of the top and bottom surfaces of the track, respectively; and
(ii) the track has a flat bottom surface, a flat top surface, and two inclined or arc-shaped upper side surfaces, and wherein the track is configured such that two pairs of upper guide wheels and two pairs of lower guide wheels on a mounting seat of the inspection robot system roll along the two inclined or arc-shaped upper side surfaces and the bottom surface of the track, respectively;
wherein each of the upper guide wheels in the items (i) and (ii) is a flanged wheel which has a wheel body with a flange, and a fillet arc is arranged between the flange and the wheel body, and
wherein a flange surface of the flanged wheel close to the track is a beveled surface, forming an angle A with a plane perpendicular to a rotational axis of the upper guide wheel, where 2°<A≤20°.
